(19) United States
(12) Patent Application Publication
(10) Pub. No.: US 2003/0183320 A1
(43) Pub. Date: Oct. 2, 2003

(54) Vehicle repair method and kit

(76) Inventor: Wilford D. Nienberg, Lexington, SC (US)

Correspondence Address: MICHAEL A. MAN, NEXSEN PRUET JACOBS & POLLARS, LLC, PO DRAWER 2426, COLUMBIA, SC, 29202-2426, US

(21) Appl. No.: 10/107,611

(22) Filed: Mar. 27, 2002

(51) Int. Cl. B32B 35/00

(52) U.S. Cl. 156/94; 156/280; 206/225

(57) ABSTRACT

A method and vehicle damage repair kit is disclosed; the method including the steps of restoring the contours of a damaged vehicle surface, encircling the restored surface with a foam masking tape, adhering the foam masking to the vehicle surface, adhering a sheet of translucent paper over the foam masking tape, cutting out a portion of the sheet so that a hole is left within the encircled surface area, priming the exposed area, sanding the primed area, and painting the sanded area.

### 1. FIELD OF THE INVENTION

The present invention relates generally to vehicle repair methods and, in particular, to a method for repairing damage to the contour and coating of a vehicle surface.

### 2. BACKGROUND OF THE INVENTION

Many methods are known for repairing damage to the surface of vehicles. Typically, these methods involve a combination steps including restoring the shape of the damaged area on the vehicle, priming the area, sanding the primed area, and thereafter painting the area. In particular, the priming and painting steps require the masking of certain portions of the surface of the vehicle to prevent overspray. For example, the trim and windows on a vehicle must be protected from primer and paint coats. Additionally, it is necessary to mask painted portions of a vehicle to prevent primer and paint overspray.

Current masking operations are a time consuming, and therefore expensive, part of the vehicle repair process. Such masking operations often include the use of masking tape and paper to cover portions of a vehicle. Specifically, paper must be cut into pieces of various shapes and sizes according to which areas of the car need to be covered and which areas need to remain exposed. Next, the paper is taped down to the vehicle with masking tape. The masking tape must also be cut into pieces of various lengths according to the various sizes and shapes of the paper that is being taped to the vehicle surface. Consequently, masking the area surrounding the vehicle damage typically involves hours of tedious labor, especially when the area includes any type of deviation from an otherwise smooth surface such as a raised door handle or ornamental features.

Other masking methods include the use of chemical masking solutions. Although these methods decrease the amount of time required to mask the automobile as compared to the masking tape methods, problems associated with chemical masking solutions include potential harm to areas of the vehicle from exposure to the chemical solution, as well as difficulty in removing the chemical solutions from the vehicle surface. Further, these chemical masking solutions typically include hazardous wastes that must be handled in accordance with environmental regulations. Therefore, those using the chemical solutions are also faced with the problem and inconvenience of having to properly dispose of these solutions so as not to harm the environment.

Accordingly, there remains a need for an improved repair and masking method for damaged vehicles that is efficient and cost-effective, and that provides protection to the vehicle surface.

### SUMMARY OF THE INVENTION

According to its major aspects and briefly stated, the present invention is a method for masking damaged portions of a vehicle surface for priming. In particular the masking method includes the following steps: 1) restoring the contour of a damaged vehicle surface; 2) encircling the restored area of a vehicle surface with foam masking tape having pressure sensitive adhesive; 3) covering the encircled area of the vehicle, as well as the surrounding areas of the vehicle, with a sheet of paper or plastic; 4) applying pressure manually to the areas of the paper or plastic covering the foam masking tape; 5) adhering the paper or plastic to the foam masking tape; 6) cutting out a portion of the paper or plastic so that the area of the vehicle surface needing to be primed is exposed; 7) priming the exposed area of the vehicle surface; and 8) removing the paper or plastic and foam masking tape; 9) sanding the primed area; and 10) painting the sanded area.

An important feature of the present invention is the use of the foam masking tape having adhesive. As opposed to typical masking tapes, this foam tape is very pliable and can easily be bent to encircle the area on the vehicle that is going to be primed. The flat masking tapes will tear or form folds if bent and must be laid down in straight lines. Therefore, these tapes must typically be cut into various lengths and then positioned so that they encircle or surround the area needing to be primed. The foam tape can be bent into any shape in accordance with the various contours of the vehicle without the need for more than one piece of tape. Accordingly, the set up time for the vehicle repair is greatly reduced.

The shape of the foam masking tape is also a feature of the present invention. Its cylindrical cross-section gradually limits the paint spray near the boundaries of the area it defines. Therefore, there is no abrupt change on the vehicular surface between primed and unprimed areas that needs to be sanded smooth. Rather, the transition is smooth. Further, the shape of the foam tape contributes to the ease in releasing the tape from the vehicle surface because one can better grip the foam tape to lift it. This feature, along with the reduced set up time, contributes substantially to the reduction in repair time and costs that are possible with the present invention.

Another important feature of the present invention is the use of pressure-sensitive adhesive material on the foam masking tape. In particular, adhesive material is located on opposite sides of the foam masking tape. On one side of the foam tape, the adhesive material is used to releasibly attach the foam tape to the surface of the vehicle. On the opposite side of the foam tape, the adhesive material is used to adhere the foam tape to the paper that covers the area of the vehicle encircled by the foam tape, as well as the surrounding areas of the vehicle. This feature is useful because it allows the placement of paper over the masking tape without careful positioning of the paper. Other types of masking tapes typically have an adhesive layer on only one side. Therefore, the paper must be carefully positioned beneath a portion of the adhesive side of the masking tape so that the tape can effectively anchor the paper to the vehicle surface. Further, the prior art may require numerous pieces of masking tape and paper depending on the location and size of the damaged area on the vehicle. In the present invention, paper need only be laid over the foam tape without extensive positioning with relation to the tape or the surface of the vehicle. Thereafter, by manually applying pressure to the paper over the area covering the foam masking tape, the paper becomes adhered to the tape. Regardless of the position of the damaged area on the vehicle, only one sheet of paper and one piece of foam tape is required. Therefore, this feature further reduces the set up time for the vehicle repair.

Yet another important feature of the present invention is the use of the combination of foam masking tape having a contrasting line and translucent paper or plastic. The translucent paper or plastic sheet allows the contrasting line to remain visible during the vehicle repair. The contrasting line is located on one side of the foam tape having adhesive material. Therefore, if the adhesive material located on the opposing side of the foam tape is used to adhere the tape to the vehicle surface, the contrasting line will be on top of the tape and face away from the vehicle surface. Once the paper or plastic is placed on top of the foam masking tape, the contrasting stripe on the foam masking tape outlines the area on which to apply pressure to the paper or plastic so as to adhere the paper or plastic to the foam tape. Further, the contrasting stripe also outlines the portion of the paper that needs to be cut so as to expose the area on the vehicle surface that is to be primed. Having the contrasting line on the foam tape allows the user to see the tape to protect the vehicle surface while cutting.

These and other features and their advantages will be clear to those skilled in the art of vehicle repair from a careful reading of the Detailed Description of Preferred Embodiments, accompanied by the following drawings.

### BRIEF DESCRIPTION OF THE DRAWINGS

In the figures,

FIG. 1 is a schematic diagram of a vehicle repair method according to a preferred method of the present invention;

FIG. 2 is a perspective view of a foam masking tape that is used in a vehicle repair method according to a preferred embodiment of the present invention;

FIG. 3A is detailed view of a vehicle showing a piece of foam masking tape encircling an area on the vehicle that is to be primed according to a preferred embodiment of the present invention;

FIG. 3B is a detailed view of a vehicle showing paper adhered to foam masking tape that encircles an area of the vehicle needing to be primed according to a preferred embodiment of the present invention;

FIG. 3C is a detailed view of a vehicle showing a cut out portion of paper that is adhered to foam masking tape exposing an area of the vehicle needing to be primed according to a preferred embodiment of the present invention;

FIG. 3D is a detailed view of a vehicle showing an area on the vehicle surface that is being primed according to a preferred embodiment of the present invention.

### DETAILED DESCRIPTION OF PREFERRED EMBODIMENT

The present invention is generally a method for repairing vehicles and, in particular, the present invention is an improved method for masking a vehicle surface subject to a coating process such as priming.

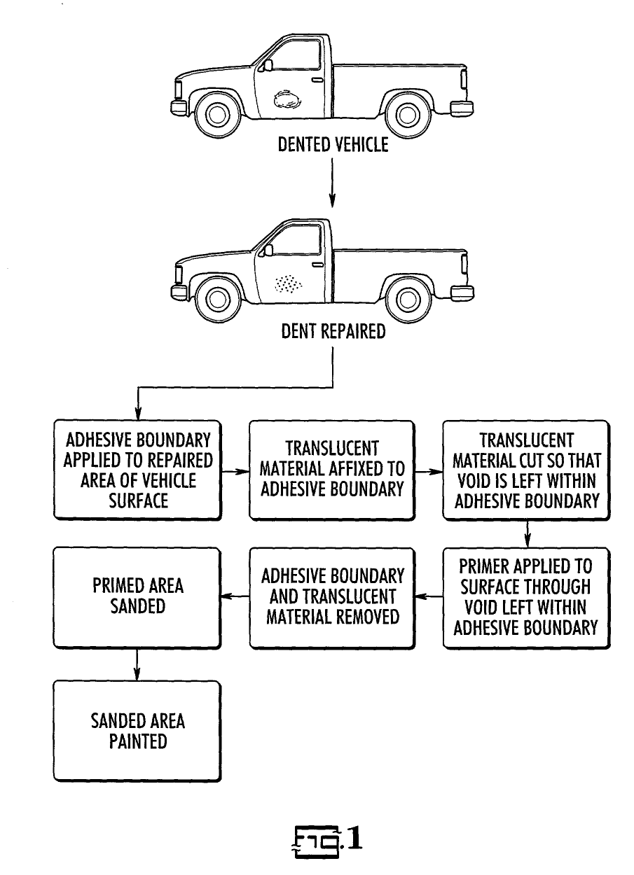

FIG. 1 illustrates a schematic of the preferred method for repairing vehicles according to the present invention. As shown, the vehicle repair method begins when a damaged vehicle is taken into a vehicle repair shop. The first step in the vehicle repair method is to restore the shape of the vehicle to its appropriate contours. Depending on the type of damage present on the vehicle, as well as the location of the damage, standard methods in the art of vehicle repair are used to restore the vehicle contours. For example, a dent on the surface of the vehicle may be pulled out by methods including the steps of heating and hammering.

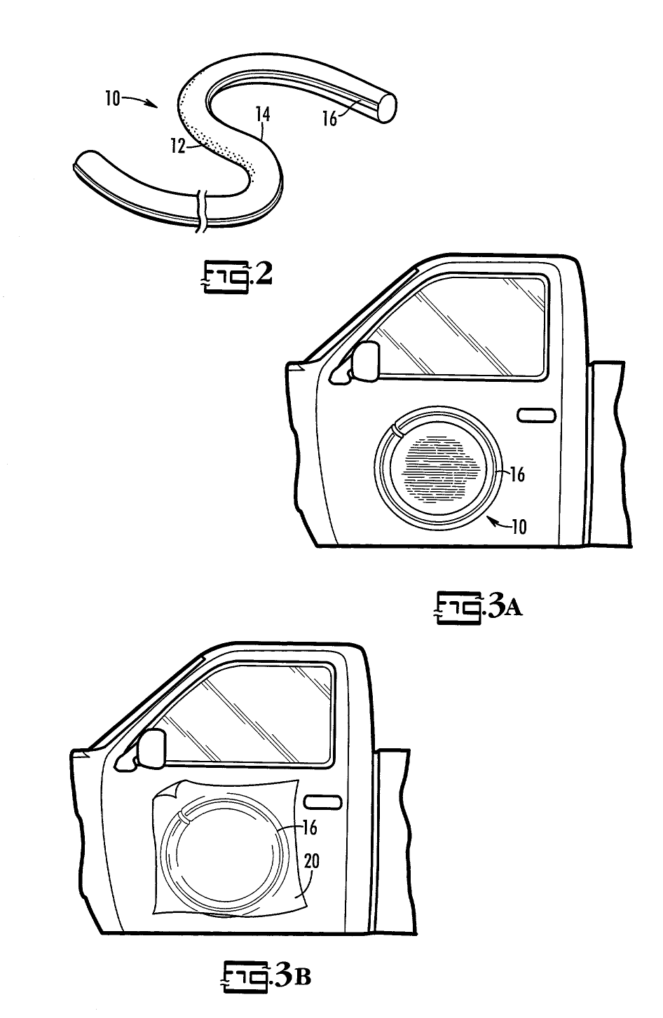

Typically, when the contour of a vehicle surface has been damaged, the coating of the vehicle surface is also affected. Therefore, the next step of the vehicle repair process is to prepare the restored area of the vehicle for priming and thereafter painting. First, the vehicle surface area that is to be primed is encircled by a foam masking tape 10, which is shown in detail in FIG. 2. This foam masking tape 10 is preferably of the type sold by Minnesota Mining & Manufacturing, Inc. As shown, the foam tape 10 is cylinder shaped having a diameter between 0.5 to 0.625 inches. Further the foam tape 10 includes strips of pressure sensitive adhesive strips 12 and 14 along the longitudinal length of the foam tape 10. These adhesive strips 12, 14 are positioned on opposing sides of the foam tape 10 so that the strips 12, 14 are approximately 180° apart. In use, one side of the foam tape 10 is turned so that one of the adhesive strips 12 is at the bottom of the foam tape 10 and the other adhesive strip 14 is located at the top of the foam tape 10. As illustrated in FIG. 2, the foam masking tape further includes a line 16 along the longitudinal length of the foam masking tape 10 that is of contrasting color to that of the foam tape 10. This contrasting line 16 is on the adhesive strip 14 that is located on top of the foam tape 10 when the tape 10 is in use. This contrasting line 16 may be formed by marking the surface of the foam masking tape 10 with a contrasting dye. Alternatively, the contrasting line 16 could be formed by applying an adhesive material of contrasting color to the surface of the foam masking tape 10. In this case, the foam tape 10 would not require an adhesive strip on the side of the tape 10 having the adhesive material of contrasting color. In either case, the contrasting line 16 is located on top of the foam masking tape 10 when the tape 10 is in use so that the contrasting line 16 will face out and away from the vehicle surface.

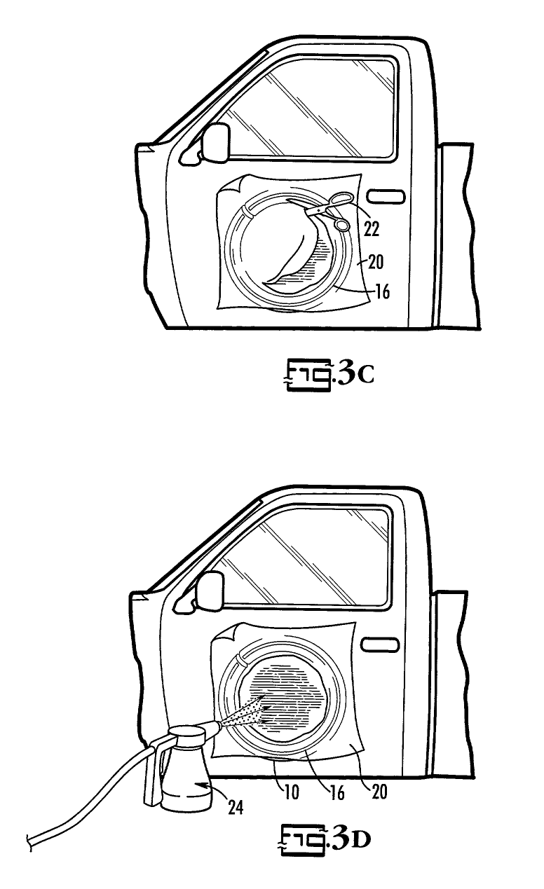

As illustrated by FIG. 3A, the foam masking tape 10 is bent so that the foam tape 10 forms a boundary around the area on the vehicle surface needing to be repaired and then is releasibly attached to the vehicle surface. Specifically, the foam masking tape 10 is adhered to the surface of the vehicle by manually applying pressure to the tape 10 while it is placed over the vehicle surface. As shown, the foam masking tape 10 is adhered so that the contrasting line 16 of the masking tape 10 faces away from the vehicle surface. The foam masking tape 16 does not form a permanent bond with the vehicle surface and releases with relative ease by manually pulling the tape 10 from the surface.

As previously described, the use of the foam masking tape 10 is a particular feature of the present invention. This foam tape 10 is more pliable than typical masking tapes used to mask vehicle surfaces. The foam tape 10 is easily bent to conform to the various contours of the vehicle surface. This feature is particularly useful in situations where the damaged area on the vehicle surface includes complex contouring such as the area adjacent to the doors of the vehicle. Regardless of the contouring of the vehicle surface, only one piece of foam masking tape 10 is needed. With other types of masking tape, excessive bending to the tape will cause tearing or folding. Accordinly, the set up time required for the present repair method is greatly reduced as compared to the prior art methods. Furthermore, the cylindrical shape of the foam tape 10 contributes to the ease in releasing the tape 10 from the vehicle surface because one can better grip the foam tape 10 to lift it.

The next step of the vehicle repair method is shown in FIG. 3B. This step involves the placing of a sheet 20 of translucent paper or plastic over the masking tape 10 and the areas surrounding and enclosed by the foam masking tape. The paper or plastic sheet 20 should be of sufficient size to cover the vehicle surface areas that need to be protected from primer or paint overspray. Once the paper or plastic sheet 20 is placed over the foam masking tape 10, the sheet 20 is adhered to the tape 10 by manually applying pressure to the sheet 20 while it is placed over the tape 10. Because the sheet 20 is preferably translucent, the contrasting line 16 on the foam tape 10 is visible through the sheet 20 and provides a guide as the where on the sheet 20 to apply pressure.

As illustrated in FIG. 3C, the next step in the vehicle repair method involves the cutting of the paper or plastic sheet 20 by a cutting means 22. Specifically, the sheet 20 is cut along the contrasting line 16 that is visible through the sheet 20 so that a void is left within the adhesive boundary set by the foam tape 10. The contrasting line 16 outlines the area that has been enclosed by the foam masking tape 10, which is the area on the vehicle needing to be primed and painted. Any type of knife or tool having a blade may be used to cut the sheet of paper or plastic, preferably a tool that holds a razer such as an EXACTO knife.

As stated above, a particular feature of the present invention is the use of the combination of foam masking tape 10 having the contrasting line 16 and the sheet 20 of translucent paper or plastic. Not only does the contrasting line 16 on the foam masking tape 10 outline the area on which to apply pressure to the paper or plastic sheet 20 so as to adhere the sheet 20 to the foam tape 10, but the contrasting line 16 also outlines the portion of the sheet 20 that needs to be cut so as to expose the area on the vehicle surface that is to be primed and painted. The translucent paper or plastic sheet 20 allows the contrasting line 16 to remain visible during the vehicle repair.

Following the exposure of the vehicle surface that is to be primed, the next step in the vehicle process is the priming of the surface. As shown in FIG. 3D, the exposed area within the enclosed boundary formed by the foam masking tape 10 is sprayed with primer by a typical means for priming 24 such as a spray gun. Once the vehicle area has been sufficiently primed, the foam tape 10 and sheet 20 of paper or plastic is removed so that the primed area on the vehicle can be sanded and thereafter painted. The vehicle surface is sanded and painted according to various standard methods in the art of vehicle repair.

As discussed previously, the cylindrical shape of the foam masking tape 10 is also a feature of the present invention. Its cylindrical cross-section gradually limits the paint spray near the boundaries of the area it defines. Therefore, there is no abrupt change on the vehicular surface between primed and unprimed areas that needs to be sanded smooth. Rather, the transition is smooth.

The materials necessary to practice this method can be provided in kit form. The kit would include a container carrying the materials, which include the foam masking tape 10, the sheet 20 of translucent material, and cutting means 22. Alternatively, the kit would also include an abrasive material for sanding, primer, paint, and adhesive material of contrasting color.

It will be apparent to those skilled in the art that many changes and substitutions can be made to the preferred embodiment herein described without departing from the spirit and scope of the present invention.

What is claimed is:

1. A method for repairing damage on the surface of a vehicle, said damage affecting the contours and paint of said vehicle, comprising the steps of:
restoring the contours of said damaged surface of said vehicle;
encircling said restored surface with a foam tape;
covering said foam tape with a sheet of material;
cutting out a portion of said material so that said restored surface is exposed; and
priming said restored surface.

2. The method as recited in claim 1, further comprising the step of sanding said primed surface.

3. The method as recited in claim 2, further comprising the step of painting said sanded surface.

4. The method as recited in claim 1, further comprising the step of providing a foam tape having a top and bottom adhesive strip along the longitudinal length of said foam tape, wherein said foam tape is adhered to said restored surface by said bottom adhesive strip.

5. The method as recited in claim 4, further comprising the step of placing a line along the longitudinal line of said foam tape so that said line is on said top adhesive strip, said line being of contrasting color to that of said foam tape.

6. The method as recited in claim 5, wherein said sheet of material is a translucent sheet of material and wherein said method further comprises the step of adhering said foam tape to said sheet by said top adhesive strip, wherein said contrasting line is visible through said sheet.

7. The method as recited in claim 6, further comprising the step of cutting said sheet along said contrasting line so as to expose said restored surface.

8. A method for repairing damage on a surface of a vehicle, said damage affecting the contours and paint of said vehicle, comprising the steps of:
restoring the contours of said damaged surface of said vehicle;
encircling said restored surface with a foam tape, said foam tape having an adhesive strip;
adhering said foam tape to said restored surface by said adhesive strip;
covering said foam tape with a sheet of material;
cutting out a portion of said material so that said restored surface is exposed; and
priming said restored surface.

9. The method as recited in claim 8, further comprising the step of sanding said primed surface.

10. The method as recited in claim 9, further comprising the step of painting said sanded surface.

11. The method as recited in claim 9, further comprising the step of applying adhesive material to the top of said foam tape, wherein said adhesive material has contrasting color to that of said foam tape, and wherein said adhesive material adheres said sheet to said foam tape.

12. The method as recited in claim 11, further comprising the step of providing a sheet of translucent material, so that said contrasting adhesive material is visible through said translucent sheet.

13. The method as recited in claim 12, further comprising the step of cutting said translucent sheet along said contrasting adhesive material so as to expose said restored surface.

14. A kit for repairing damage on a surface of a vehicle, said damage affecting the contours and paint of said vehicle, comprising:
a container;
a spool of foam masking tape carried within said container; and
a sheet of material carried within said container.

15. The kit as recited in claim 14, further comprising a cutting tool.

16. The kit as recited in claim 14, further comprising an adhesive material having color that is contrasting to that of said foam masking tape.

17. The kit as recited in claim 14, further comprising an abrasion means.

18. The kit as recited in claim 14, further comprising a primer.

19. The kit as recited in claim 14, further comprising a container of paint.

20. The kit as recited in claim 14, wherein said foam masking has an adhesive strip along the longitudinal length of said foam masking tape.
